(19) United States
(12) Patent Application Publication
(10) Pub. No.: US 2016/0325323 A1
(43) Pub. Date: Nov. 10, 2016

(54) THE USE OF A JETTING PROCESS FOR DECONTAMINATING CONTAMINATED SOIL OR THE CONTENTS OF SUPPLY OR STORAGE TANKS

(71) Applicant: Reinhard HEUSER, Linkenheim-Hochstetten (DE)

(72) Inventor: Reinhard HEUSER, Linkenheim-Hochstetten (DE)

(21) Appl. No.: 14/917,337

(22) PCT Filed: Sep. 9, 2013
(86) PCT No.: PCT/EP2013/068598

§ 371 Date: Jul. 18, 2016

(51) Int. Cl. B09C 1/08; B09C 1/10; B09C 1/00

(52) U.S. Cl. CPC B09C 1/08; B09C 1/00; B09C 1/10; B09C 2101/00

(57) ABSTRACT

The present invention relates to use of a nozzle jet method for decontamination of contaminated soil, wherein a liquid decontamination agent is introduced into the soil.

### BACKGROUND OF THE INVENTION

1. Field of Invention

The present invention relates to use of a nozzle jet process for decontamination of contaminated soil or the content of a supply or storage tank.

2. Brief Description of Related Art

In developing technical processes that are, for example, connected with products containing petroleum, it repeatedly happens that petroleum unintentionally gets into the soil and contaminates the ground. Other products, especially chemical ones, but also gasoline, for example, can cause similar damage. If no preventive measures are taken, these materials can seep into the soil. Oil spills can be serious, with more or less oil penetrating into the soil in unprotected areas. A danger exists of ground water contamination, which has to be counteracted quickly and effectively.

Oils is a collective designation for more or less viscous, mostly organic chemical liquids. In terms of chemical composition, distinctions are made between fatty, ether, mineral and silicone oils. Among the fatty oils, liquid, semi-solid and solid goods are of plant and animal origin. Oils are transported and stored in tank containers. Due to their properties, plant-based and animal-based oils and fats are subjected to various alterations, which must be taken into account during transport and storage. If oils are stored for too long, they can thicken and assume a solid consistency. It is then very costly in time and money terms to remove such oils and fats.

Methods are known from prior art for decontamination of oil-contaminated soil. The various methods are selected, as a rule, depending on the severity of the ground contamination. For example, for smaller oil spills and pollution, binding agents are used, which however, then need to be disposed of at great expense.

With major contaminations, the contaminated soil is buried, and likewise disposed of at great expense. A further possibility also consists in burning the soil, which represents a very costly solution. Large-area contaminations are known to be very time-consuming and can be controlled only at high cost.

Another option is the use of biological methods with microorganisms. Here, oil-decomposing microorganisms are inserted into the soil with a carrier fluid, for example by seepage, via wells, but also with injection lances, so that the microorganisms may be as well dispersed as possible. Attention must be paid in this connection to the direction of ground water flow, since the microorganisms are to be introduced in the direction of flow to the contaminated area. However, homogeneous distribution of microorganisms, and, linked with that, breakdown of the oil contamination leaving no residue, are not guaranteed.

### SUMMARY OF THE INVENTION

It is the object of the invention to create a reliable method for decontamination of contaminated soil, which acts over a wide area and is able to be applied virtually independent of the ground condition. This method should also be suited to be able to remove oils in solid form from storage tanks.

The object is attained according to the invention in that a nozzle jet method is used for decontamination of contaminated soil, by which a liquid decontaminating agent is introduced into the soil or into the solid or solidified oily or fatty content of storage tanks.

The nozzle jet method is known in various versions from construction engineering and is applied there to create, for example, a cement-ground mixture body, to produce better bearing capacity of a supporting medium. For this, an injection lance drills into the soil, and then the soil, under high pressure, is mixed with a binding-agent suspension containing cement.

This could also be implemented with an injection method, but the injection method operates at low pressures. Thus, the grain structure, the grain composition, the compactness and the water permeability of the soil have a great influence on the distribution of the injected material, which is disadvantageous for the present invention.

The idea that is the basis for the invention, is to use the known nozzle jet method for decontamination of the contaminated soil, in order—in contrast to the known application—to insert the liquid decontaminating agent into the soil instead of the binding agent suspension containing cement. In contrast to the injection method, the nozzle jet method operates at a considerably higher pressure, with the effective area substantially increased in the soil for decontamination in advantageous fashion. Also the distribution of the liquid decontamination agent in the soil is considerably more homogeneous when using the nozzle jet method.

According to the invention, the nozzle jet method can also be used to break down old oils in storage and transport tanks, however. Here also, the lance bores into solidified and thickened oil, and then the decontamination agent is injected. The tanks can be stationary or be on the sea or in a vehicle. To the extent that reference is made in the description that follows to the soil, then the procedural steps are equally valid for breaking down of solidified oils or fats in the storage tanks.

With the invention-specific method, the liquid decontamination agent is introduced into the soil at an outflow rate of greater than 50 m per second, especially of greater than 100 m per second. While doing so, the outflow pressure of the liquid decontamination agent reaches at least 300 bar and advantageously 570 to 630 bar. Since with the invention-specific method, the injection lance can drill as deep as desired into the soil, the depth of the effective area of decontamination in the soil can be precisely set. With this, in advantageous fashion the injection lance can be introduced into the soil at any desired angle between horizontal and vertical. Thus, with a single borehole, an area of up to 3 meters in diameter can be treated with the liquid decontamination agent. By lining up such pillar-shaped injection areas in rows one on another, a broad, spatially inclusive distribution of the liquid decontamination agent in the soil is possible, even down to great depths.

With this, the invention-specific method can also be used in very fine-grained soils, like silts, that extend to a clay limit. An additional advantage is that with the invention-specific method the ground structure and the soil structure is broken up by the high-pressure nozzle jets. In the active area of the nozzles, the liquid decontamination agent mixes almost homogeneously with the soil. Contaminants are reached by the high pressure of the liquid decontamination agent, independent of the condition, composition and consistency of the soil. Thus the liquid contamination agents have possibility of ensuring a decomposition process and breakdown of the contamination leaving no residue.

In one preferred embodiment of the method, a tenside is used as the liquid decontamination agent, which preferably serves for decontamination of oil-contaminated soil. Tensides possess a property of generating very low surface tension. For example, in a mixture of oil- and grease-containing substances with water, the tenside acts as an emulsifier and thus leads to a very finely-dispersed oil-water emulsion. In addition, tensides are biodegradable. For example, the liquid decontaminating agent of the invention-specific method preferably is a mixture of various tensides, which are manufactured, for example, from hemp oil and yeast. The result is that this tenside mixture biodegrades especially well, and rapidly, since the microorganisms that provide for the breakdown, break this natural tenside mixture down with the oil or grease-containing substances more quickly than a chemically produced tenside.

The tensides, or the tenside mixtures, can also be mixed from the outset with microorganisms. For example, in individual cases an oil spill can be responded to by selecting especially suitable microorganisms for the special purpose, for example in the sea, in a sandy area, or in a very warm or very cold environment. For example, the University of Greifswald Institute for Microbiology maintains a collection of microorganisms, especially with various oil-decomposing microorganisms, wherein effective appropriate microorganisms can be chosen for various applications.

Complete decontamination can occur with this within about 30 days, and happens automatically, not affected by external influences, through the decomposition process of the emulsion in the soil. The temporal duration of the decomposition process is dependent on temperature. However, the method is not limited to decontamination of oil contaminations in soil, but also covers decontamination of contaminations in soil in an area of heavy oil up to highly volatile hydrocarbons.

In a simple form of the invention-specific method (simplex method), the liquid decontamination agent is injected via a nozzle of an injection lance, with the injection lance inserted into a borehole previously drilled into the soil. This is a simple and thus cost-effective method, which does not set severe conditions for the soil condition.

In a further-developed embodiment of the invention-specific method (duplex method), the injection jet is additionally sheathed by compressed air. This occurs, for example, via a ring nozzle on the free end of the injection lance, which ejects the decontamination agent in the center and the compressed air in the outer area. The compressed air serves to enlarge the effective area for decontamination, in that the compressed air provides additional erosion of the soil.

In still another further development of the invention-specific method (triplex method), with a water jet sheathing the compressed air, the soil is pre-eroded and then the liquid decontamination agent is injected. When injecting, the device is preferably impinged on by a low pressure. The low pressure, for one, has less of an effect on the microorganisms; at high pressures the microorganisms can be damaged, with the decontaminating effect then being impaired. For another, the lower pressure in the injection lance results in less wear on the nozzle head.

When using the invention-specific method, if needed be, after the injection process has been started, the injection is slowly drawn while constantly turning. Thus the effective area is correspondingly increased, even deep in the soil, since the invention-specific method can be applied in various layers, or in a large area of the soil along the borehole.

According to the invention, deviating from the known nozzle jet method, the liquid decontaminating agent can be inserted up to the surface of the soil, to especially treat the area that is directly under the ground surface, with the liquid decontamination agent. As a rule, this is the area of the soil that is most heavily contaminated.

Regardless of which method (the simplex, duplex or triplex method) is selected, the method applied in each case is more cost-effective than the known conventional soil breakdown with disposal afterwards. For this, a homogeneous distribution of the liquid decontamination agent and a breakdown of the contamination connected with that, is ensured.

Further features and advantages of the present invention are explained in greater detail in what follows, using the figures. With this, the features indicated can also individually be the subject of the invention, as well as in any combinations that deviate from the described and depicted combination.

### BRIEF DESCRIPTION OF THE DRAWING

FIGS. 1 to 4, in four procedural steps, show the sequence of the invention-specific method.

### DETAILED DESCRIPTION OF THE INVENTION

The invention-specific method represents a reliable method for decontamination of contaminated soil, that works over a wide area and is applicable almost independent of the soil condition.

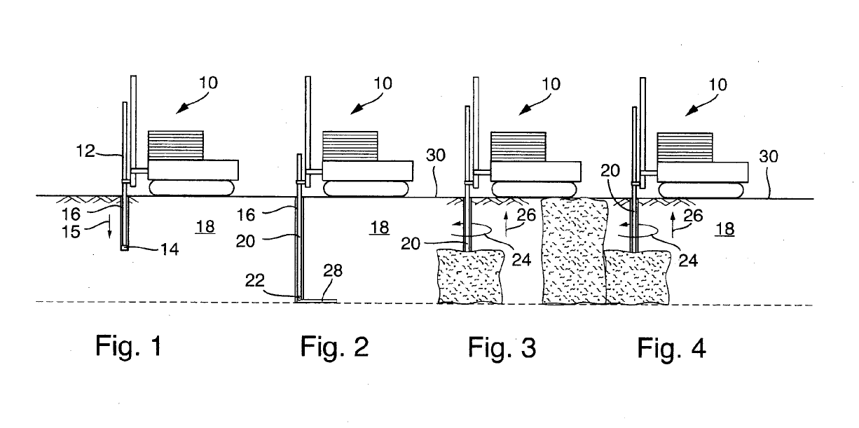

As FIG. 1 shows, initially, using a drilling device 10, a drill pipe 12 with a drill bit 14 at the free end of the drill pipe 12 drills down (see arrow 15) and thus a borehole 16 is generated in the soil 18. As a rule, a flushing flow assists in this process, and keeps the borehole 16 and the drill pipe 12 open for borehole fluid to be flushed out. Special drill bits 14 are used for especially hard soil 18 and for rock. The borehole 16 shown in FIG. 1 is introduced vertically into the soil 18; however, it is also possible to have boreholes 16 that are at any desired angle between vertical and horizontal, depending on the form of the area.

In a second procedural step, as per FIG. 2, an injection lance 20 is inserted down to the lowest point in the borehole 16. In a preferred embodiment form, the so-called triplex method, the injection lance 20 has a ring nozzle 22 on its free end. The ring nozzle 22 comprises multiple outflow areas for various media. On the one hand, a water flow that encases the compressed air is ejected from ring nozzle 22, and on the other hand, the operation of injection lance 20 can be switched, so that a liquid decontamination agent is emitted.

In the invention-specific method, initially the water jet encasing the compressed air is activated, with it emerging at a pressure of about 600 bar and with a flow rate of over 100 m per second from ring nozzle 22. With this the soil 18 is eroded, which means that the ground structure of the soil 18 is loosened or dissolved.

Then the operation of injection lance 20 is switched over to emitting the liquid decontamination agent, so that the actual injection jet issues from ring nozzle 22 for decontamination. With this, a lower pressure is necessary, since the soil 18 is appropriately prepared to receive the liquid decontamination agent.

Then the injection lance 20 is withdrawn (see arrow 26) in step fashion while being constantly rotated (see arrow 24) from the borehole 16, and the above-described process, namely the introduction of the water jet encasing the compressed air, and then introduction of the liquid decontamination agent, is repeated at various depths in borehole 16, as FIG. 3 shows. By rotating injection lance 20, the liquid decontamination agent is introduced at every depth in the soil 18 at an angle of 360° horizontally.

Due to the invention-specific method a pillar-shaped area 28 is created in the soil 18, in which the liquid decontamination agent is homogeneously distributed. Due to the invention-specific method, pillar-shaped area 28 can have a diameter of about 3 meters. The pillar-shaped area 28 with the liquid decontamination agent is thus built up from below to directly beneath the earth surface 30 (see FIG. 4).

Then the procedural steps shown in FIGS. 1 to 3 are repeated at positions on the earth surface 30 that are displaced from each other, so that a large area of the soil 18 is treated with the liquid decontamination agent (see FIG. 4). The individual boreholes 16 are preferably placed at an interval of about 2.5 to 3 meters on the earth surface 30.

The invention-specific method preferably serves for decontamination of oil-contaminated soil 18, in which a tenside mixture is used as the liquid decontamination agent. The tenside mixture emulsifies the oil from the soil 18 with water, and causes the emulsion to be able to be biodegraded especially quickly with the aid of microorganisms or bacteria. This means that the actual decontamination proceeds automatically, without further interventions after the tenside mixture is introduced into the soil 18. The tenside mixture is capable of decontaminating oil-contaminated soil 18 within about 30 days.

In an alternative method, the separate operational step of introducing the water jet encasing the compressed air can be dispensed with, and the injection jet can be immediately encased by compressed air.

In a method still further simplified, the injection jet is injected into the soil 18 directly via a simple nozzle, with no encasing compressed air.

Also known is a nozzle jet method that can be used for the invention-specific method, in which, with the aid of a cutting jet, which also can be encased by air, the soil is partially cut or milled out. The cutting jet can have water, compressed air and/or injection liquid.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

1-10. (canceled)

11. A nozzle jet method for decontamination of contaminated soil (18) or the contents of storage tanks, wherein subsequent to an injection lance drilling into the contaminated soil or the contents of the storage tanks, a liquid decontamination agent is inserted into the contaminated soil (18) or the contents, characterized in that the liquid decontamination agent is introduced into the contaminated soil (18) or the contents via an injection jet sheathed by compressed air.

12. A nozzle jet method of claim 11, characterized in that the liquid decontamination agent comprises a tenside.

13. A nozzle jet method of claims 11, characterized in that an oil-contaminated soil (18) is decontaminated.

14. A nozzle jet method of claim 11, characterized in that the nozzle jet method comprises introducing the liquid decontamination agent into the contaminated soil (18) or the contents at an outflow rate of greater than 50 m per second, preferably greater than 100 m per second.

15. A nozzle jet method of claim 11, characterized in that the nozzle jet method comprises introducing the liquid decontaminating agent into the contaminated soil (18) or the contents at a pressure of greater than 400 bar, preferably of 600 (+/− 20) bar.

16. A nozzle jet method of claim 11, characterized in that the liquid decontamination agent is introduced into the contaminated soil (18) or the contents at any desired angle between horizontal and vertical.

17. A nozzle jet method of claim 11, characterized in that the liquid decontamination agent is injected via a nozzle (22) of an injection lance (20).

18. A nozzle jet method of claim 11, characterized in that the liquid decontamination agent is introduced up to the surface of the soil (18) or of the contents.

19. A nozzle jet method of claims 12, characterized in that an oil-contaminated soil (18) is decontaminated.

20. A nozzle jet method of claim 12, characterized in that the nozzle jet method comprises introducing the liquid decontamination agent into the contaminated soil (18) or the contents at an outflow rate of greater than 50 m per second, preferably greater than 100 m per second.

21. A nozzle jet method for decontamination of contaminated soil (18) or the contents of a storage tank, wherein, subsequent to an injection lance drilling into the contaminated soil or the contents of the storage tank, a liquid decontamination agent is injected into the contaminated soil (18) or the contents, characterized in that the contaminated soil (18) or the contents are eroded in a first operational step with a water jet encasing a compressed air, and then in a second operational step the liquid decontamination agent is injected into the contaminated soil (18) or the contents, wherein with an injection of the liquid decontamination agent, a lower pressure is used than with an introduction of the water jet encasing the compressed air.

22. A nozzle jet method of claim 21, characterized in that the liquid decontamination agent comprises a tenside.

23. A nozzle jet method of claim 21, characterized in that an oil-contaminated soil (18) is decontaminated.

24. A nozzle jet method of claim 21, characterized in that the nozzle jet method comprises introducing the liquid decontamination agent into the contaminated soil (18) or the contents at an outflow rate of greater than 50 m per second, preferably greater than 100 m per second.

25. A nozzle jet method of claim 21, characterized in that the nozzle jet method comprises introducing the liquid decontaminating agent into the contaminated soil (18) or the contents at a pressure of greater than 400 bar, preferably of 600 (+/− 20) bar.

26. A nozzle jet method of claim 21, characterized in that the liquid decontamination agent is introduced into the contaminated soil (18) or the contents at any desired angle between horizontal and vertical.

27. A nozzle jet method of claim 21, characterized in that the liquid decontamination agent is injected via a nozzle (22) of an injection lance (20).

28. A nozzle jet method of claim 21, characterized in that the liquid decontamination agent is introduced up to the surface of the contaminated soil (18) or of the contents.

29. A nozzle jet method of claims 22, characterized in that an oil-contaminated soil (18) is decontaminated.

30. A nozzle jet method of claim 22, characterized in that with the nozzle jet method, the liquid decontamination agent is introduced into the contaminated soil (18) or the contents at an outflow rate of greater than 50 m per second, preferably greater than 100 m per second.
